(19) United States
(12) Patent Application Publication
(10) Pub. No.: US 2019/0044847 A1
(43) Pub. Date: Feb. 7, 2019

(54) METHOD FOR TRANSMITTING DATA IN A MULTIPATH COMMUNICATION

(71) Applicant: FONDATION B COM, Cesson Sevigne (FR)

(72) Inventors: Fabrice GUILLEMIN, Pleumeur Bodou (FR); Patrice HOUZE, Rennes (FR)

(73) Assignee: FONDATION B COM, Cesson Sevigne (FR)

(21) Appl. No.: 16/075,837

(22) PCT Filed: Feb. 3, 2017
(86) PCT No.: PCT/EP2017/052333

§ 371 Date: Aug. 6, 2018

(30) Foreign Application Priority Data
Feb. 8, 2016 (FR) 1650982

(51) Int. Cl. H04L 12/707; H04L 12/863; H04L 12/841; H04L 12/807; H04L 12/805

(52) U.S. Cl. CPC H04L 45/24; H04L 47/6295; H04L 47/36; H04L 47/27; H04L 47/283

(57) ABSTRACT

In the context of a transmission of data for a multipath communication from source terminal equipment to destination terminal equipment, the method: establishes, on at least one multipath communication path, a plurality of connections with the destination terminal equipment; for each path on which a said plurality of connections was established, selecting to make it active at least one connection among the plurality of established connections, the other established connections being put in reserve; distributing the data between the selected connections, referred to as active connections, in accordance with at least one predefined distribution rule, and transmitting the distributed data. Upon detecting a transmission incident via an active connection on a path on which a said plurality of connections was established, the method closes said active connection, and makes active a connection that had been put in reserve on said path.

The present invention relates to a multipath communication of data from source terminal equipment to destination terminal equipment via a communication network, and more particularly a management of a transmission incident in the context of the multipath communication in order to avoid head-of-line blocking situations.

In the context of data transmissions from source terminal equipment to destination terminal equipment, there may exist a plurality of communication paths for allowing transmission of said data. Some transmission technologies allow exploiting existence of such a plurality of paths, so as in particular to increase the bandwidth made available to the source terminal equipment for transmitting said data to the destination terminal equipment. Relying on the TCP (Transmission Control Protocol) transport protocol as described in the normative document RFC 793, the MPTCP (Multipath TCP) technology as described in the normative document RFC 6824 has thus been developed. Using a multipath communication technology, the source terminal equipment establishes, with the destination terminal equipment, various connections on respective paths, and, between these various connections, distributes the data to be transmitted.

Since the connections are established on separate paths, the data that pass through these connections are subject to different transmission constraints from one connection to another. This is all the more true when the connections are based on heterogeneous physical links (e.g. one connection passes through a communication network of the Wi-Fi (registered trade mark) type, whereas another connection passes through a mobile telecommunication network in accordance with technology promoted by the 3GPP (Third Generation Partnership Project) organisation, such as for example GPRS (General Packet Radio Service), UMTS (Universal Mobile Telecommunications System) or LTE (Long-Term Evolution). Head-of-line blocking situations may then arise, which is particularly detrimental in the context of real-time applications that impose a time constraint on the availability of the data in reception. Indeed, if a data loss occurs on a path A that is used in the context of a multipath communication and which causes a mean end-to-end transmission latency much higher than on at least one other path B used in the context of said multipath communication, then this significant difference in transmission latencies between the paths A and B causes significant desequencings of data at the destination terminal equipment. The loss of data means that numerous data received by the destination terminal equipment are put in a receiving queue, as long as the destination terminal equipment actually receives the lost data thanks to a retransmission mechanism activated by the source terminal equipment for the path A, and a phenomenon of head-of-line blocking then arises. Head-of-line blockages may arise merely through the significant difference in transmission latencies between the paths A and B, but the data loss amplifies the phenomenon when said data loss occurs on the path A which has the highest average end-to-end transmission latency.

It is desirable to overcome these drawbacks of the prior art. It is more particularly desirable to limit, or even to prevent, head-of-line blocking situations occurring in multipath communications, in particular when significant differences in transmission latencies exist between the various paths followed by said multipath communications. It is also desirable to be able to use, in the context of connections established for these multipath communications, transmission protocols in connection oriented mode that are standard, such as TCP, which are now well supported by the network infrastructure equipment through which the communication paths of the multipath communication path.

The present invention relates to a method for transmitting data in the context of a multipath communication from source terminal equipment to destination terminal equipment. The method is such that it comprises the following steps: establishing, on at least one path of the multipath communication, a plurality of connections from the source terminal equipment to the destination terminal equipment; for each path on which a plurality of connections has been established, selecting to make it active at least one connection among said plurality of connections, the other established connections being put in reserve; and distributing the data between the selected connections, referred to as active connections, according to at least one predefined distribution rule, and transmitting the distributed data. Upon detecting a transmission incident via an active connection on a path on which one said plurality of connections has been established, the method is further such that it comprises the following steps: closing said active connection, and making active a connection that had been put in reserve on said path. Thus, by closing the active connection where the transmission incident was detected, the method cuts short the retransmissions of data via this connection, and makes available again, for distributing data between the paths, a new connection (which had been put in reserve on said path). Putting in reserve at least one connection allows ensuring that the multipath communication benefits without delay from a new connection on the path where the transmission incident was detected. The loss of the faulty connection is thus compensated for by a set of more efficient active connections, which allows limiting, or even avoiding, head-of-line blocking situations.

According to a particular embodiment, a plurality of connections is established from the source terminal equipment to the destination terminal equipment for each path in the multipath communication. Thus, the multipath communication is more robust to transmission incidents, such as losses of data packet, which may arise on any one of said paths.

According to a particular embodiment, after having established each said plurality of connections, a single connection is selected to make it active for each path on which one said plurality of connections has been established. Thus, the distribution of the data between the various paths enables implementing a load fairness policy between said paths.

According to a particular embodiment, the method implementing a congestion management mechanism based on a congestion window protocol for each active connection, the method initialises the congestion window of the connection that was made active following the transmission incident, according to a slow-start mechanism. Thus, the method has a prudent and friendly behaviour, which limits the risks of loss of data via the connection that was made active following the transmission incident, and which allows a gradual search for a suitable congestion window size.

According to a particular embodiment, the method implementing a congestion management mechanism based on a congestion window protocol for each active connection, the method initialises the congestion window of the connection that was made active following the transmission incident, to a maximum allowable size value. Thus, the method can be more effective, since it does not waste rising time when the distribution of data will mean that the connection that was made active following the transmission incident is actually used.

According to a particular embodiment, the method implementing a congestion management mechanism based on a congestion window protocol for each active connection, the method initialises the congestion window of the connection that was made active following the transmission incident, to a size value equal to a size value that the congestion window of the connection where the incident was detected had before being closed. Thus, the method exploits the a priori knowledge of the current characteristics of the path in question.

According to a particular embodiment, after having closed the connection where the incident was detected, the method establishes a new connection on the path on which the closed connection had been established, the new connection being put in reserve. Thus, the method has sufficient connections in reserve to absorb the transmission incidents.

According to a particular embodiment, the method establishes, for each said plurality of connections, a quantity Q of connections such that:

$$Q = ⌈ 1 + \frac{max ( {t}_{1} , {t}_{2} )}{RTT} ⌉$$

where [x] represents the ceiling integer part of x, t₁ represents a time necessary for establishing a connection between the source terminal equipment and the destination terminal equipment, t₂ represents a time necessary for closing a connection between the source terminal equipment and the destination terminal equipment, and RTT represents a mean round-trip time along the path on which said plurality of connections was established. Thus, the method always has sufficient connections in reserve for absorbing the transmission incidents, since the method takes into account the times for closure and establishment of a connection, these times being related to the mean round-trip time along the path in question.

According to a particular embodiment, the method extracts data present in a sending queue associated with the connection where the incident was detected, and redistributes the extracted data between the active connections of the multipath communication according to at least one predetermined redistribution rule. Thus, the absorption of the transmission incident in terms of transmission latency is improved.

According to a particular embodiment, the method comprises a classification of the active connexions according to mean transmission latencies that said active connections involve respectively from the source terminal equipment to the destination terminal device, and redistributes said data between the active connections at least according to said classification. Thus the absorption of the transmission incident in terms of transmission latency is further improved.

According to a particular embodiment, the method also performs a prior step of grouping connections to be transmitted in data units of size below a minimum value of the maximum segment lengths negotiated for the multipath communication paths, and the method distributes the data units between the active connections. Thus, the redistribution of the data following the closure of the connection where the transmission incident was detected is facilitated, since there is no need to make new data regroupings to adapt to the different capacities of the paths on which said active connections have been established.

According to a particular embodiment, the redistribution comprises, for at least one sending queue associated with an active connection: an identification, among the data of said queue, of data transmitted to the destination terminal device but not acknowledged and of data awaiting transmission to the destination terminal device;

and an insertion of the data to be redistributed, among said data awaiting transmission. Thus, the absorption of the transmission incident in terms of transmission latency is further improved.

According to a particular embodiment, following the extraction of the data from the queue of the connection where the incident was detected, the redistribution of data comprises an insertion of the extracted data at the head of an upstream queue, with a view to distribution thereof between the active connections according to said predefined distribution rule or rules. Thus, application of said predefined redistribution rule or rules is guaranteed.

According to a particular embodiment, the method places the extracted data in an offloading buffer, and the method further comprises the following steps: selecting at least one active connection for redistributing the data stored in the offloading buffer; closing each selected active connection; making active a connection that had been put in reserve on each path for which one selected active connection was closed; and extracting data present in a sending queue associated with each selected active connection that was closed, and placing them in the offloading buffer, with a view to redistribution thereof. Thus the redistribution of the data following the closure of the connection where the transmission incident was detected is facilitated, since there is no need to bother with renumbering (sequencing) data already present in sending queue, while enabling implementing a load fairness policy between said paths.

According to a particular embodiment, the method extracts data present in a sending queue associated with a connection where the incident was detected, and uses, for transmitting said data, a substitute connection that had been put in reserve on a path other than the one where the connection where the incident was detected had been established. Thus, the data that were present in the sending queue associated with the connection where the incident was detected are transmitted in a simple fashion, on a substitute connection, whose sending queue does not contain any other data, therefore limiting the risks that a new transmission incident might occur.

According to a particular embodiment, when the connection that had been put in reserve is made active following the transmission incident, the method implements a test phase vis-à-vis said connection, in which the method transmits data both via said connection and via at least one other active connection so as to create data redundancy, until said connection made active shows a transmission latency below a predefined threshold. Thus, the redistribution of the data following the closure of the connection where the transmission incident was detected is facilitated, since there is no need to bother with renumbering (sequencing) data already queued for sending.

The invention also relates to equipment configured to enable source terminal equipment to transmit data in the context of a multipath communication from the source terminal equipment to destination terminal equipment. Said equipment is such that it comprises a computing machine configured to: establish, on at least one path of the multipath communication, a plurality of connections with the destination terminal equipment; for each path on which a plurality of connections was established, select to make it active at least one connection among said plurality of established connections, the other established connections being put in reserve; and distribute the data between the selected connections, referred to as active connections, according to at least one predefined distribution rule, and transmit the distributed data. In addition, the computing machine is configured to, upon detecting of a transmission incident via an active connection on a path on which one said plurality of connections was established, close said active connection, and make active a connection that had been put in reserve on said path.

The invention also relates to a computer program containing instructions for implementing the method mentioned above in any one of its embodiments, when said computer program is executed by a processor. The invention also relates to an information storage medium storing such a computer program.

The features of the invention mentioned above, as well as others, will emerge more clearly from a reading of the following description of an example embodiment, said description being given in relation to the accompanying drawings, among which:

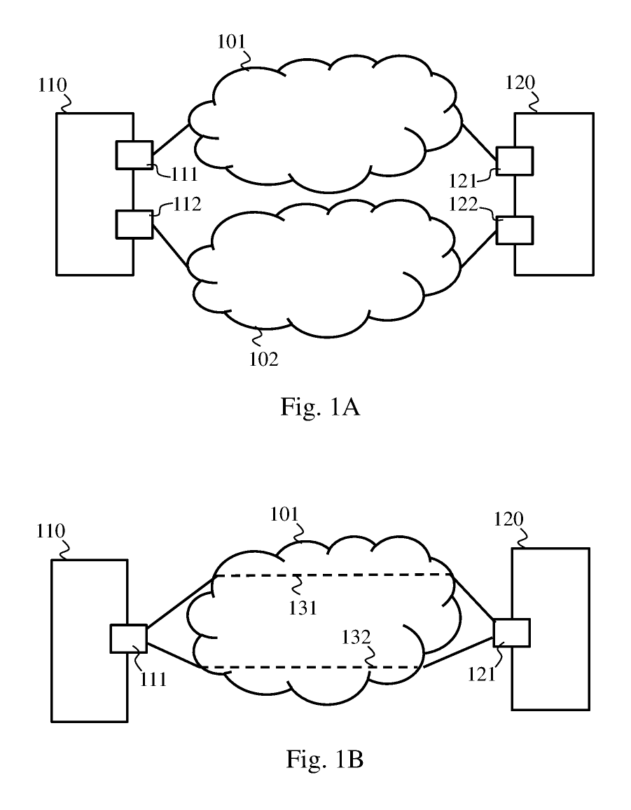

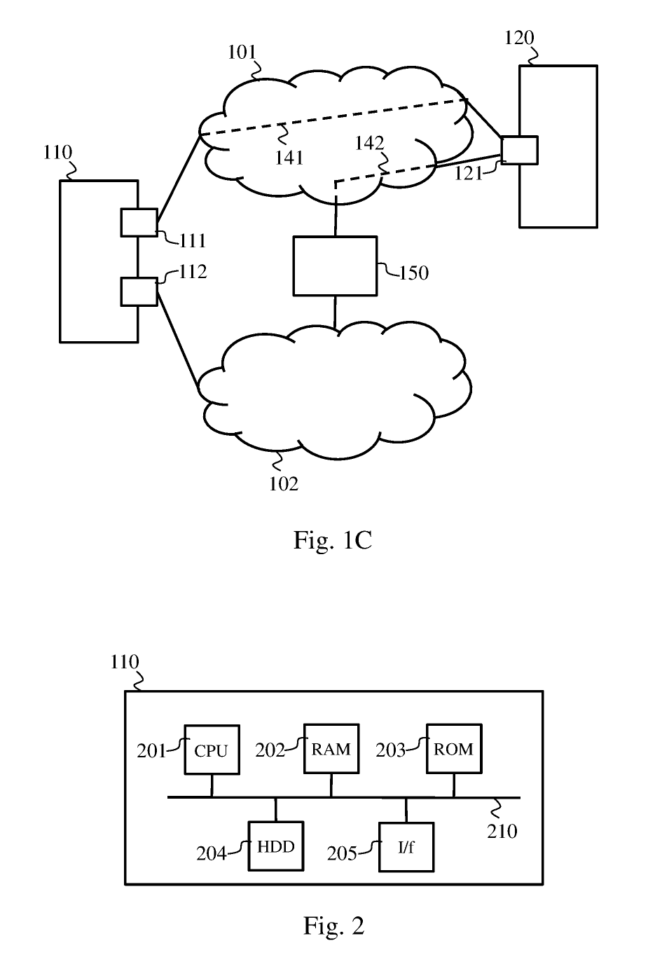

FIG. 1A illustrates schematically a first example of a communication system in which the invention may be implemented.

FIG. 1B illustrates schematically a second example of a communication system in which the invention may be implemented.

FIG. 1C illustrates schematically a third example of a communication system in which the invention may be implemented.

FIG. 2 illustrates schematically an example of hardware architecture of source terminal equipment;

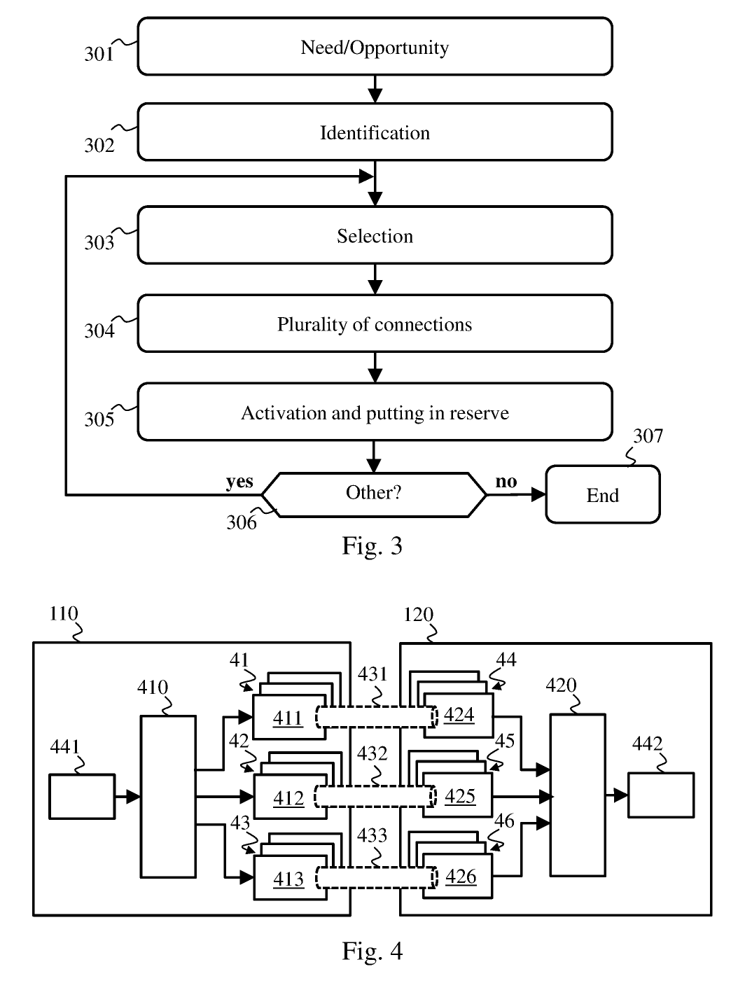

FIG. 3 illustrates schematically an algorithm, implemented by the source terminal equipment, for initialising a multipath communication with destination terminal equipment;

FIG. 4 illustrates schematically a configuration of a communication system resulting from an execution of the algorithm in FIG. 3;

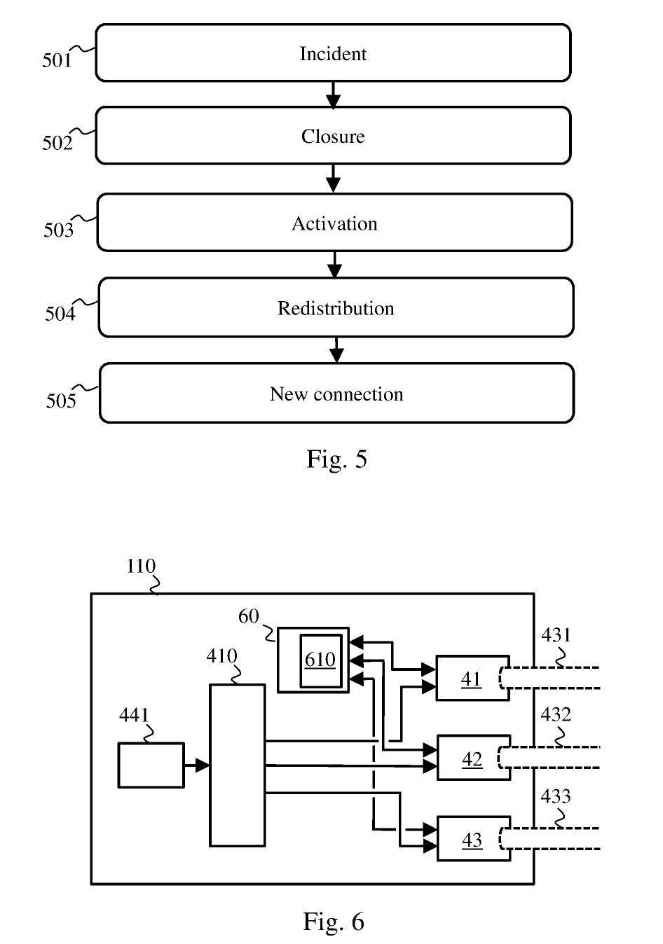

FIG. 5 illustrates schematically an algorithm, implemented by the source terminal equipment, for managing a data transmission incident in the context of the multipath communication with the destination terminal equipment; and

FIG. 6 illustrates schematically a configuration of the source terminal equipment in a particular embodiment of the invention.

To avoid head-of-line blocking situations occurring in the context of a multipath communication from source terminal equipment to destination terminal equipment, it is proposed a method establishing, on at least one path of the multipath communication, a plurality of connections from the source terminal equipment to the destination terminal equipment. Then, for each path on which a said plurality of connections has been established, at least one connection is selected, among said plurality of connections, to make it active, and the other established connections are put in reserve. The data are then distributed via the selected connections, referred to as active connections, in accordance with at least one predefined distribution rule with a view to transmission thereof in the context of the multipath communication. Then, upon detecting a transmission incident via an active connection on a path on which one said plurality of connections has been established, the method closes said active connection, and makes active a connection that had been put in reserve on said path. Equipment configured to allow the implementation of the method is also proposed.

FIGS. 1A to 1C described hereafter show various examples of a communication system in which a plurality of communication paths exist between two terminal equipment, and therefore in which the invention may be implemented.

FIG. 1A illustrates schematically a first example of a communication system in which the invention may be implemented. In this first example, the communication system comprises source terminal equipment 110 and destination terminal equipment 120. The use of the term equipment means that the source terminal equipment 110 and the destination terminal equipment 120 can respectively take the form of a single device or a set of interconnected devices for performing the functions and operations for which said equipment is responsible. Hereinafter, it is considered by way of illustration that the source terminal equipment 110 and the destination terminal equipment 120 are respectively single devices.

The source terminal device 110 comprises a first interface 111 configured to enable the source terminal device 110 to communicate via a first communication network 101, and a second interface 112 configured to enable the source terminal device 110 to communicate via a second communication network 102. In a similar manner, the destination terminal device 120 comprises a first interface 121 configured to enable the destination terminal device 120 to communicate via the first communication network 101, and a second interface 122 configured to enable the destination terminal device 120 to communicate via the second communication network 102. For example, the first communication network 101 is a Wi-Fi (registered trade mark) network, as described in the IEEE 802.11 family of standards, and the second communication network 102 is an Ethernet (registered trade mark) network, as described in the IEEE 802.3 family of standards. In this first example, there exists at least one communication path via the first communication network 101, and at least one other communication path via the second communication network 102, to enable the source terminal device 110 to transmit data to the destination terminal device 120 in the context of a multipath communication.

FIG. 1B illustrates schematically a second example of a communication system in which the invention may be implemented. In this second example, the source terminal device 110 and the destination terminal device 120 are interconnected solely by the first communication network 101, in which there exist at least two communication paths 131, 132, to enable the source terminal device 110 to transmit data to the destination terminal device 120 in the context of a multipath communication. For example, the first communication network 101 is a mesh packet or circuit switched network.

FIG. 1C illustrates schematically a third example of a communication system in which the invention may be implemented. In this third example, the source terminal device 110 is connected to the first communication network 101 and to the second communication network 102 in the same way as in the first example shown in FIG. 1A, and the destination terminal device 120 is connected to the first communication network 101 in the same way as in the second example shown in FIG. 1B. A gateway device 150 being configured to interconnect the first 101 and second 102 communication networks, there exists at least one communication path via the first communication network 101, and at least one other communication path via the gateway device 150, to enable the source terminal device 110 to transmit data to the destination terminal device 120 in the context of a multipath communication. For example, the first communication network 101 is the Internet accessed by the source terminal device 110 via a Wi-Fi (registered trade mark) access point, and the second communication network 102 is a UMTS or LTE (Long-Term Evolution) network.

FIG. 2 illustrates schematically an example of hardware architecture of the source terminal device 110. The destination terminal device 120 can be arranged according to the same example of hardware architecture.

According to the example in FIG. 2, the source terminal device 110 comprises, connected by a communication bus 210: a processor or CPU (Central Processing Unit) 201; a random access memory (RAM) 202; a read-only memory (ROM) 203; a storage unit 204 or a storage medium reader, such as an SD (Secure Digital) card reader or a hard disk drive (HDD); at least one interface I/f 205, such as for example the interfaces 111 and 112 mentioned in relation to FIGS. 1A and 1C, configured to enable the source terminal device 110 to communicate via at least one respective communication network.

The processor 201 is capable of executing instructions loaded into the RAM memory 202 from the ROM memory 203, from an external memory (not shown), from a storage medium (such as an SD card), or from a communication network (potentially other than the first 101 and second 102 communication networks). When the source terminal device 110 is powered up, the processor 201 is capable of reading instructions from the RAM memory 202 and executing them. These instructions form a computer program causing the implementation by the processor 201 of all or some of the algorithms and steps described hereafter.

All or some of the algorithms and steps described hereafter may be implemented in software form by the execution of a set of instructions by a programmable machine or a computing machine, for example a processor, a DSP (Digital Signal Processor) or a microcontroller, or be implemented in hardware form by a computing machine or a dedicated component, for example an FPGA (Field-Programmable Gate Array) or an ASIC (Application-Specific Integrated Circuit).

In a variant embodiment, the invention relates to a computing machine, or a processor, or a dedicated component, as described above, and configured to cause the implementation, by the source terminal device 110, of all or some of the algorithms and steps described hereafter.

FIG. 3 illustrates schematically an algorithm, implemented by the source terminal device 110, for initialising a multipath communication with the destination terminal device 120.

In a step 301, the source terminal device 110 detects a need or an opportunity for establishing a multipath communication with the destination terminal device 120. The source terminal device 110 detects having to transmit data to the destination terminal device 120 and knows that a plurality of paths enables joining the destination terminal device 120. In other words, the source terminal device 110 detects that it has the opportunity to perform a multipath communication with the destination terminal device 120.

In a following step 302, the source terminal device 110 identifies each of the communication paths on which the multipath communication has to rely.

In a following step 303, the source terminal device 110 selects a communication path among the communication paths identified at the step 302, for example arbitrarily. Predefined selection rules may be applied so that the source terminal device 110 can decide which communication path to select preferentially among the communication paths identified at the step 302.

In a following step 304, the source terminal device 110 establishes a plurality of connections with the destination terminal device 120 via the communication path selected at the step 303. When each connection is established, an initialisation protocol is set up before being able to transmit useful data. This initialisation protocol consists typically of a three-way handshake, whose objective is to share sequence numbers used, by successive increments along with the transmissions of data, in order to ensure that the data are delivered to a receiving application of the destination terminal device 120 in accordance with the same sequence as the one in accordance with which said data were supplied by a sending application of said source terminal device 110. Each one of said connections is preferentially established in accordance with the TCP protocol. Other protocols may however be used, provided that these protocols offer possibilities of establishing connections between the terminal device 110 and the destination terminal device 120, as well as flow control and congestion control mechanisms.

In a particular embodiment, the source terminal device 110 establishes a quantity Q of such connections which has been fixed by default; for example, two connections are thus established at the step 304 for the communication path selected at the step 303.

In another particular embodiment, the terminal device 110 establishes a quantity Q of such connections, which was fixed as follows:

$$Q = ⌈ 1 + \frac{max ( {t}_{1} , {t}_{2} )}{RTT} ⌉$$

where [x] represents the ceiling integer part of x, t₁ represents a time necessary for establishing a connection between the source terminal device 110 and the destination terminal device 120, t₂ represents a time necessary for closing a connection between the source terminal device 110 and the destination terminal device 120, and RTT represents a mean round-trip time along the communication path selected at the step 303 (namely in substance twice the transmission latency from the terminal device 110 to the destination terminal device 120 via the communication path selected at the step 303). This allows reducing the time necessary for subsequently activating a connection that has to replace another connection, of said plurality of connections, which has had to be closed following a transmission incident.

The value of the mean round-trip time along the communication path selected at the step 303 is obtained by statistics as transmissions with acknowledgement go along the communication path selected at the step 303. If no statistical data is available at the time of establishment of the multipath connection, the source terminal device 110 establishes a quantity Q of such connections that was fixed by default, and subsequently adjusts the quantity Q of these connections when statistical data relating to the communication paths selected at the step 303 enable the source terminal device 110 to determine the mean round-trip time along said communication path.

In a following step 305, the terminal device 110 selects, to make it active, at least one connection among the plurality of connections that were established at the step 304 for the communication path selected at the step 303. Selecting a connection to make said connection active amounts to configuring the connection, and the mechanisms that are inherent therein, such as flow control and congestion control, to make said connection usable for transmitting data. Each active connection is thus identified as being usable for transmitting data by applying at least one predefined distribution rule. The terminal device 110 puts in reserve each other connection in said plurality of connections that were established for the communication path selected at the step 303. Each connection put in reserve is thus identified as not being taken into account in the application of the predefined distribution rule (or rules).

Preferentially, in the step 305, the terminal device 110 selects, to make it active, a single connection among the plurality of connections that were established at the step 304 for the communication path selected at the step 303, each other connection in said plurality of connections that were established for the communication path selected at the step 303 being put in reserve.

In a following step 306, the terminal device 110 checks whether the establishment of the multipath communication also has to take into account at least one other communication path among the communication paths identified at the step 302. If such is the case, the step 303 is reiterated by selecting such another communication path among the communication paths identified at the step 302; otherwise a step 307 is performed, in which the algorithm in FIG. 3 is ended.

The algorithm in FIG. 3 shows that a plurality of connections is thus preferentially established for each one of the communication paths on which the multipath communication has to rely. It is however possible to establish such a plurality of connections only for a quantity Q′ of communication paths among a quantity N of communication paths on which the multipath communication has to rely, with 0<Q′<N. For example, Q′=1. It is in particular possible to establish such a plurality of connections only for each communication path having an average transmission latency above a threshold that was predetermined according to the lowest average transmission latency among said communication paths on which the multipath communication has to rely, each other path then having only one connection (the multipath character of the communication thus being preserved). For example, taking the example of FIG. 1C in which the first communication network 101 is the Internet accessed via a Wi-Fi (registered trade mark) access point and the second communication network 102 is a UMTS or LTE network, it is in particular possible to establish such a plurality of connections only for the path passing through the second communication network 102 and a single connection for the path passing through the first communication network 101.

FIG. 4 illustrates schematically a communication system configuration that results from an execution of the algorithm in FIG. 3 so as to establish a multipath communication from the source terminal device 110 to the destination terminal device 120 relying on a plurality of communication paths 431, 432, 433. By way of illustration, the configuration in FIG. 4 considers that a plurality of connections was established for each path of the multipath communication.

According to the configuration in FIG. 4, the source terminal device 110 comprises an upstream queue 441 dedicated to the multipath communication established with the destination terminal device 120. The upstream queue 441 is configured to receive and temporarily store a data sequence, issuing from the sending application (not shown) of said source terminal device 110, with a view to transmission thereof to the destination terminal device 120 via said multipath communication. In a similar manner, the destination terminal device 120 comprises a downstream queue 442 dedicated to the multipath communication established with the source terminal device 110. The downstream queue 442 is configured to store the data received from the source terminal device 110, with a view to transfer thereof to the receiving application (not shown) of the destination terminal device 120.

In addition, the source terminal device 110 comprises a scheduler 410 responsible for distributing the data contained in the upstream queue 441 between the various communication paths, applying the predefined distribution rule (or rules). The scheduler thus typically applies predefined load balancing rules between the various communication paths, which may in particular take into account the maximum segment size (MSS) information and/or maximum transmission unit (MTU) length information negotiated for the active connections, and/or which may take into account information on transmission latencies via the active connections, and/or which may take into account quantities of data already transmitted and/or quantities of data awaiting acknowledgement via the active connections. The predefined distribution rules may be such that one or more active connections are not necessarily used at any time. This may in particular depend on the transmission latency (and therefore on the round-trip time) found via this active connection (or connections). In particular, there may be circumstances according to which, although a connection has just been made active on a path, it is not immediately fully used by the source terminal device 110 since the transmission latency currently found via this active connection is above a predefined threshold. It is the role of the scheduler 410 to decide via which active connection the data contained in the upstream queue 441 shall be sent to the destination terminal device 120, and to decide whether such an active connection or another shall actually be used at a given moment. The algorithm in FIG. 3 does however ensure that each path has an active connection, meaning one that is actually usable for transmitting to the destination terminal device 120 data contained in the upstream queue 441.

Similarly, the destination terminal device 120 comprises an assembler 420 responsible for reconstructing the data sequence from the data received via the various communication paths, and storing the reconstructed data sequence in the downstream queue 442.

By applying the algorithm in FIG. 3, a plurality of connections has been established for each one of the paths of the multipath communication between the source terminal device 110 and the destination terminal device 120. A sending queue and a receiving queue are implemented for each one of the established connections. Thus: the source terminal device 110 implements a plurality of sending queues 41, and the destination terminal device 120 implements a plurality of receiving queues 44, for the respective connections established on the communication path 431; the source terminal device 110 implements a plurality of sending queues 42, and the destination terminal device 120 implements a plurality of receiving queues 45, for the respective connections established on the communication path 432; and the source terminal device 110 implements a plurality of sending queues 43, and the destination terminal device 120 implements a plurality of receiving queues 46, for the respective connections established on the communication path 433. Since only one connection is active per communication path, a single sending queue 411 is activated in the plurality of sending queues 41, and a single receiving queue 424 is activated accordingly in the plurality of receiving queues 44; a single sending queue 412 is activated in the plurality of sending queues 42, and a single receiving queue 425 is activated accordingly in the plurality of receiving queues 45; and a single sending queue 413 is activated in the plurality of sending queues 43, and a single receiving queue 426 is activated accordingly in the plurality of receiving queues 46.

Each one of the connections that were established by applying the algorithm in FIG. 3 is independent of the other connections thus established. Each one of the connections therefore has its own flow control mechanism and its own congestion control mechanism, and is therefore able to allow the source terminal device 110 to detect transmission incidents (such as data losses) occurring in the context of the multipath communication with the destination terminal device 120, and to determine to which connections said transmission incidents are respectively related. Each one of the active connections in the context of the multipath communication from the source terminal device 110 to the destination terminal device 120 is autonomous.

Within the active connections, the source terminal device 110 sends data bytes in accordance with a congestion management mechanism based on a window protocol. The bytes are numbered thanks to sequence numbers and are sent in accordance with a window, referred to as congestion window, with a size of w bytes, which means that no more than w bytes can be sent in the context of the connection in question without waiting to be acknowledged. The size w of the connection window is adjusted according to change in the transmission conditions on the communication path on which the connection in question is established, without however exceeding a maximum allowable value wmax. As already mentioned, each one of the active connections in the context of the multipath communication from the source terminal device 110 to the destination terminal device 120 is preferentially in accordance with the TCP protocol, and the management of the congestion window is for example in accordance with TCP Reno or TCP CUBIC.

Transmission incidents may occur in the context of each one of the active connections established for transmitting data from the source terminal device 110 to the destination terminal device 120. As detailed hereafter, the source terminal device 110 closes an active connection that is subjected to a transmission incident in order to cancel the retransmission mechanisms that will be triggered on this connection, and then relies on a connection that had been put in reserve, in order to quickly provide an alternative to the connection that has thus been closed, so as to limit, or even prevent, head-of-line blocking situations occur.

FIG. 5 illustrates schematically an algorithm, implemented by the source terminal device 110, for data transmission incident management in the context of the multipath communication with the destination terminal device 120.

In a step 501, the source terminal device 110 detects a transmission incident occurring on an active connection of the multipath communication with the destination terminal device 120. Such a transmission incident is for example: a data packet loss, a time-delay expiry associated with the sending of a data item without an acknowledgement having been received for said data item from the destination terminal device 120, a reactivation of a slow-start mechanism of the congestion control of said connection, etc. A slow-start is a technique known to persons skilled in the art consisting of initialising a connection with a congestion window size equal to a minimum value (for example equal to one segment), and the side of the window is doubled at each round-trip time until it reaches a predetermined threshold from which the increase in the congestion window size becomes linear. Such a mechanism is found in the TCP protocol for example.

In a following step 502, a source terminal device 110 closes the active connection on which the transmission incident detected at the step 501 occurred. The data that were present in the sending queue associated with said connection and which were not acknowledged by the destination terminal device 120 are kept in order to be preferentially redistributed, in accordance with at least one predetermined redistribution rule, between the active connections of the multipath communication. For this data redistribution, the source terminal device 110 typically applies predefined load balancing rules between the various communication paths, which may in particular take into account the maximum segment size (MSS) and/or information on the maximum transmission unit (MTU) lengths negotiated for the active connections, and/or which may take into account information on transmission latencies via the active connections.

In a following step 503, the source terminal device 110 activates a connection that had been put in reserve for the communication path on which the connection that was closed at the step 502 was established. The connection activated at the step 503 replaces the connection that was closed at step the 502, and is thus usable for distributing the data to be transmitted to the destination terminal device 120. The fact that this replacement connection is actually used or not, or at what moment this replacement connection is actually used, depends on the aforementioned distribution rules.

Closing the active connection and activating a reserve connection allows rapid reaction to the transmission incident, e.g. packet loss, without having to make any modification with regard to the individual behaviour of each connection. This allows in particular using standard connection protocols, such as TCP, which are now well supported by the equipment of network infrastructures through which the communication paths of the multipath communication pass. No modification to the network infrastructure equipment already available off the shelf is thus required.

In a particular embodiment, the source terminal device 110 implementing a congestion management mechanism based on a window protocol for each active connection, the source terminal device 110 initialises the congestion window of the connection activated at the step 503 in accordance with a slow-start mechanism, also known by the term exponential growth algorithm, during which the size of said congestion window is doubled at regular intervals of duration equal to the round-trip time via the connection in question.

According to a variant embodiment, the source terminal device 110 implementing a congestion management mechanism based on a window protocol for each active connection, the source terminal device 110 initialises the size of the congestion window of the connection activated at the step 503 to a maximum value allowed for said size.

According to another variant embodiment, the source terminal device 110 implementing a congestion management mechanism based on a window protocol for each active connection, the source terminal device 110 initialises the size of the congestion window of the connection activated at the step 503 to the congestion window size that the connection that was closed at the step 502 had before the closure.

In a following step 504, the source terminal device 110 redistributes between the active connections the data that were previously intended to be transmitted via the connection that was closed at step the 502 and which were not acknowledged by the destination terminal device 120 (considering in particular that the data that had not yet been transmitted have, by definition, not been acknowledged by the destination terminal device 120). The redistribution takes place in accordance with at least one predetermined redistribution rule, as already mentioned. This step is performed by the scheduler 410 in the context of the configuration that was presented in relation to FIG. 4.

Preferentially, the source terminal device 110 performs a classification of the active connections according to the average transmission latencies that said active connections involve respectively, and the source terminal device 110 redistributes said data between the active connections according to at least said classification, favouring the connections involving the lowest average transmission latencies among said active connections.

In a particular embodiment, the source terminal device 110 performs regroupings of data in a sending queue according to information on maximum segment size (MSS) and/or information on a maximum transmission unit (MGU), both negotiated between the source terminal device 110 and the destination terminal device 210 for the connection with which said sending queue is associated. The source terminal device 110 removes, from the sending queue associated with the connection that was closed at the step 502, the data that were not acknowledged by the destination terminal device 120 and, when the source terminal device 110 redistributes said data between the active connections, the source terminal device 110 performs new regroupings of data according to information on maximum segment size (MSS) and/or information on the maximum transmission unit (MTU), both negotiated between the source terminal device 110 and the destination terminal device 120 for at least one active connection to which the data redistribution is performed. When the maximum segment size (MSS) and/or the maximum transmission unit (MTU) which have been negotiated for an active connection to which the redistribution of data is performed are respectively less than the maximum segment size (MSS) and/or the maximum transmission unit (MTU) which had been negotiated for the closed connection, then new regroupings are thus performed. In a preferential variant, the source terminal device 110 (and more particularly the scheduler 410), prior to the placing of the data in a sending queue, performs regroupings of data in data units of size M less than a minimum value of the maximum segment sizes (MSS) negotiated for the multipath communication paths. Thus, the data are transmitted by data units of size M on the active connections, and it is avoided having to make new regroupings when the data of the closed connection are redistributed between the active connections available to the source terminal device 110.

In a particular embodiment, in a variant or in addition to the previous one, taking the illustration in FIG. 4, the source terminal device 110 withdraws, from the sending queue associated with the connection that was closed at the step 502, all the data contained in said sending queue, namely the data awaiting transmission and those in the course of transmission but not yet acknowledged. The source terminal device 110 identifies, for each sending queue associated with an active connection, the data transmitted but not acknowledged and the data awaiting transmission. Thus, when the data that were in the sending queue of the connection where the transmission incident was detected are redistributed, the source terminal device 110 inserts the data of the sending queue of the connection where the transmission incident was detected among the data not yet transmitted of the sending queue of at least one active connection. For example, the source terminal device 110 determines, for each sending queue associated with an active connection, a boundary between data transmitted to the destination terminal device 120 but not acknowledged and data not yet transmitted to the destination terminal device 120. The source terminal device 110 then inserts, at said boundary of at least one sending queue associated with an active connection, at least some of the data that were withdrawn from the sending queue associated with the connection that was closed at the step 502, so that all the data removed from the sending queue associated with the connection that was closed at the step 502 are thus redistributed. In this particular embodiment, it may be necessary to revise sequence numbers that have now been attributed by the source terminal device 110 to the data awaiting transmission in which the data that were withdrawn from the sending queue associated with the connection that was closed at the step 502 are inserted. The sequence numbers that would have been attributed by the source terminal device 110 in the context of the connection that was closed are replaced by sequence numbers corresponding to the place at which said data are inserted in the sending queue of the active connection to which the data redistribution is performed, the sequence numbers of the data that were then already present in said sending queue then being increased accordingly.

To avoid having to revise the sequence numbers in the sending queues in which are inserted the data that were extracted from the sending queue of the connection that was closed at the step 502, the source terminal device 110 may use, for transmitting said data, a substitute connection that had been put in reserve on another path. Said substitute connection is then not considered to be active by the scheduler 410 for applying the aforementioned distribution rules, but merely serves in a temporary fashion for emptying the sending queue of the connection that was closed at the step 502. In a particular embodiment, when the data that were extracted from the sending queue of the connection that was closed at the step 502 have finally been transmitted via the substitute connection, said substitute connection is closed and a new connection is established in order to be put in reserve.

In another particular embodiment, taking the illustration in FIG. 4, the source terminal device 110 removes from the sending queue associated with the connection that was closed at the step 502 all the data contained in said sending queue, namely the data awaiting transmission and those in the course of transmission but not yet acknowledged. The source terminal device 110 then inserts said data at the head of the buffer 441, so that the scheduler 410 redistributes said data between the active connections, applying the aforementioned distribution rules.

Yet another particular embodiment is detailed hereafter in relation to FIG. 6.

In a following step 505, the source terminal device 110 preferentially establishes a new connection with the source terminal device via the communication path on which the connection that was closed at step the 502 was established. The source terminal device 110 puts in reserve the connection established at the step 505, so that the number of connections established for the communication path in question is the same as before the connection closure performed at the step 503. It is also possible to choose not to have a constant number of connections established for each communication path.

As already mentioned, there may be circumstances according to which, although a connection has just been made active on a path, it is not immediately fully usable by the source terminal device 110, otherwise a new transmission incident might be created. A particular embodiment then consists in the source terminal device 110 implementing a test phase vis-à-vis the connection that had been put in reserve and which has become active following a transmission incident. In this test phase, the source terminal device 110 transmits data both via the connection in question and via at least one other active connection (and therefore on at least one other respective path) so as to create data redundancy, until said connection in question shows a transmission latency below a predefined threshold.

FIG. 6 illustrates schematically a configuration of the source terminal device 110 in a particular embodiment implementing the invention.

The configuration in FIG. 6 repeats in a simplified manner the configuration of the source terminal device 110 as already presented in relation to FIG. 4. The scheduler 410 and the upstream queue 441 appear therein. The plurality of sending queues 41, the plurality of queues 42 and the plurality of receiving queues 43, respectively established on the communication paths 431, 432, 433, also appear therein. The configuration in FIG. 6 also shows an incident manager 60 responsible for performing the hereafter-described operations of extracting data and redistributing the extracted data. The configuration in FIG. 6 also shows that the incident manager 60 has an offloading buffer 610.

By virtue of such an arrangement, when a transmission incident occurs on a connection established in the context of the multipath communication, the source terminal device 110 removes, from the sending queue associated with said connection (which was closed at the step 502), all the data contained in said sending queue, namely the data awaiting transmission and those in a course of transmission but not yet acknowledged. The source terminal device 110 then stores these data in the offloading buffer 610. To redistribute the data stored in the offloading buffer 610, the source terminal device 110 selects at least one active connection among the plurality of active connections available to the source terminal device 110, and the source terminal device 110 closes each active connection thus selected, when the sending queue associated with said active connection is not empty. The source terminal device 110 removes, from the sending queue associated with each connection thus closed, all the data contained in said sending queue, namely the data awaiting transmission and those in the course of transmission but not yet acknowledged. The source terminal device 110 then places the data thus extracted in the offloading buffer 610, with a view to redistribution thereof. In addition, the source terminal device 110 makes active a connection that had been put in reserve on each path for which an active connection was thus closed. The source terminal device 110 then, for at least one subset of the multipath communication paths, has available active connections whose associated sending queues are empty. The source terminal device 110 then redistributes the data stored in the offloading buffer 610 among these active connections whose associated sending queues are empty. This approach allows avoiding having to revise the sequence numbers in the sending queues in which are inserted the data that were extracted from the sending queue of the connection where the transmission incident was detected.

1. A method for transmitting data in the context of a multipath communication from source terminal equipment to destination terminal equipment, wherein the method comprises:
establishing, on at least one path of the multipath communication, a plurality of connections from the source terminal equipment to the destination terminal equipment;
for each path on which a plurality of connections has been established, selecting to make it active at least one connection among said plurality of established connections, the other established connections being put in reserve; and
distributing the data between the selected connections, referred to as active connections, according to at least one predefined distribution rule, and transmitting the distributed data;
and, upon detecting a transmission incident via an active connection on a path on which one said plurality of connections has been established:
closing said active connection; and
making active a connection that had been put in reserve on said path.

2. The method according to claim 1, wherein a plurality of connections is established from the source terminal equipment to the destination terminal equipment for each path in the multipath communication.

3. The method according to claim 1, wherein, after having established each said plurality of connections, a single connection is selected to make it active for each path on which one said plurality of connections has been established.

4. The method according to claim 3, wherein, the method implementing a congestion management mechanism based on a congestion window protocol for each active connection, the method initializes the congestion window of the connection that was made active following the transmission incident, according to a slow-start mechanism.

5. The method according to claim 3, wherein, the method implementing a congestion management mechanism based on a congestion window protocol for each active connection, the method initializes the congestion window of the connection that was made active following the transmission incident, to a maximum allowable size value.

6. The method according to claim 3, wherein, the method implementing a congestion management mechanism based on a congestion window protocol for each active connection, the method initializes the congestion window of the connection that was made active following the transmission incident, to a size value equal to a size value that the congestion window of the connection where the incident was detected had before being closed.

7. The method according to claim 3, wherein, after having closed the connection where the incident was detected, the method establishes a new connection on the path on which the closed connection had been established, the new connection being put in reserve.

8. The method according to claim 1, wherein the method establishes, for each said plurality of connections, a quantity Q of connections such that:
$$Q = ⌈ 1 + \frac{max ( {t}_{1} , {t}_{2} )}{RTT} ⌉$$
where [x] represents the ceiling integer part of x, t₁ represents a time necessary for establishing a connection from the source terminal equipment to the destination terminal equipment, t₂ represents a time necessary for closing a connection from the source terminal equipment to the destination terminal equipment, and RTT represents a mean round-trip time along the path on which said plurality of connections was established.

9. The method according to claim 1, wherein the method extracts data present in a sending queue associated with the connection where the incident was detected, and redistributes the extracted data between the active connections of the multipath communication according to at least one predetermined redistribution rule.

10. The method according to claim 9, wherein the method comprises performing a classification of the active connections according to mean transmission latencies that said active connections involve respectively from the source terminal equipment to the destination terminal device, and redistributes said data between the active connections at least according to said classification.

11. The method according to claim 9, the method further comprising grouping beforehand data to be transmitted in data units of size below a minimum value of the maximum segment lengths negotiated for the paths of the multipath communication, and wherein the method distributes the data units between the active connections.

12. The method according to claim 9, wherein the redistribution comprises, for at least one sending queue associated with an active connection:
identifying, among the data of said queue, the data transmitted to the destination terminal device but not acknowledged and the data awaiting transmission to the destination terminal device; and
inserting the data to be redistributed, among said data awaiting transmission.

13. The method according to claim 9, wherein, following the extraction of the data from the queue of the connection where the incident was detected, the redistribution of data comprises an insertion of the extracted data at the head of an upstream queue, with a view to distribution thereof between the active connections according to said predefined distribution rule or rules.

14. The method according to claim 9, wherein the method places the extracted data in an offloading buffer, and the method further comprises:
selecting at least one active connection for redistributing the data stored in the offloading buffer;
closing each selected active connection;
making active a connection that had been put in reserve on each path for which a selected active connection was closed; and
extracting data present in a sending queue associated with each selected active connection that was closed, and placing them in the offloading buffer, with a view to redistribution thereof.

15. The method according to claim 1, wherein the method extracts data present in a sending queue associated with the connection where the incident was detected, and uses, for transmitting said data, a substitute connection that had been put in reserve on a path other than the one where the connection where the incident was detected had been established.

16. The method according to claim 1, wherein, when the connection that had been put in reserve is made active following the transmission incident, the method implements a test phase vis-à-vis said connection, in which the method transmits data both via said connection and via at least one other active connection so as to create data redundancy, until said connection made active shows a transmission latency below a predefined threshold.

17. A non-transitory information storage medium storing a computer program product comprising instructions for implementing the method according to claim 1, when said instructions are read from said non-transitory information storage medium and executed by a processor.

18. Equipment configured to enable source terminal equipment to transmit data in the context of a multipath communication from the source terminal equipment to destination terminal equipment, wherein said equipment comprises a computing machine configured to:
establish, on at least one path of the multipath communication, a plurality of connections with the destination terminal equipment;
for each path on which a said plurality of connections was established, select to make it active at least one connection among the plurality of established connections, the other established connections being put in reserve; and
distribute the data between the selected connections, referred to as active connections, according to at least one predefined distribution rule, and transmit the distributed data;
upon detecting a transmission incident via an active connection on a path on which a said plurality of connections was established;
close said active connection; and
make active a connection that had been put in reserve on said path.
